(19) United States
(12) Patent Application Publication
(10) Pub. No.: US 2007/0185797 A1
(43) Pub. Date: Aug. 9, 2007

(54) System and method for aggregating financial data for loan processing

(76) Inventor: Rodney Robinson, Los Altos Hills, CA (US)

Correspondence Address: PARK, VAUGHAN & FLEMING LLP, 2820 FIFTH STREET, DAVIS, CA, 95618, US

(21) Appl. No.: 11/350,168

(22) Filed: Feb. 8, 2006

(51) Int. Cl. G06Q 40/00

(52) U.S. Cl. 705/36 R; 705/38

(57) ABSTRACT

A system and method for aggregating a user's financial data for submission to a third party, as part of a loan application or other transaction. The data may include asset data (e.g., statements from bank accounts, investment accounts, retirement accounts), credit data (e.g., statements from credit providers), payroll data (e.g., a W2 statement, pay stubs), tax return data, insurance data, a credit report, etc. The system elicits information from the user to use in retrieving the data (e.g., institution name, account number, login information), retrieves the data and may validate some or all of it (e.g., to ensure it is the user's data). Tax return data may be retrieved from the user's computing device or may already be stored in the system. The system serves the data to the third party and may also package selected data for submission to another party (e.g., a loan purchaser or underwriter).

### BACKGROUND

This invention relates to the fields of computer systems and data communications.

Existing methods of assembling and submitting financial data as part of a loan application (or other financial transaction) are cumbersome and inefficient. Many types of data are required for a significant transaction (e.g., a mortgage loan), often from different sources (e.g., a banking institution, an employer, an accountant).

For example, a loan applicant may be required to submit statements for asset accounts (e.g., savings accounts, checking accounts, retirement accounts, brokerage accounts), credit accounts (e.g., credit cards, automobile loan), multiple tax returns, copies of paycheck stubs, etc. Typically, the applicant will assemble these various documents in paper form, totaling dozens of pages, and submit them via facsimile or mail, thereby generating an equal amount of paper within the organization that processes the loan application.

The applicant may need to sift through many documents to find those that are needed. Even if some data are available in electronic form, the applicant may have to print that data in order to submit it with his or her application.

The applicant may therefore spend a significant amount of time locating or obtaining documents to be submitted. This may inhibit some applicants from completing the procedure, and the amount of data that must be collected may lead to errors, such as omitting required information, providing stale data, etc. In addition, an unscrupulous applicant may alter or even fabricate a document in the hope of getting the application approved.

At the receiving end of the application process is a loan processor or other entity that must review the submitted data. For a loan processor receiving thousands or tens of thousands of applications per month, the burden of receiving, organizing and reviewing every application is onerous, and has been inescapable.

### SUMMARY

In one embodiment of the invention, a system and methods are provided for aggregating a user's financial data for submission to a third party (e.g., a loan processor), as part of a loan application or other transaction. The data may include asset data (e.g., statements from bank accounts, investment accounts, retirement accounts), credit data (e.g., statements from credit providers), payroll data (e.g., a W2 statement, pay stubs), tax return data, insurance data, a credit report, etc.

The system receives a connection from the user, possibly via a link provided to the third party and forwarded to the user. The system elicits information from the user for use in retrieving the data (e.g., institution name, account number, login information), retrieves the data and may validate some or all of it (e.g., to ensure it is the user's data). Tax return data may be retrieved from the user's computing device or may already be stored in the system if the system is operated by an organization that provides tax return software.

The system may allow the user to select which data is to be provided to the third party. The third party then connects to the system and the system serves the data to the third party. The system may also package selected data for submission to another party (e.g., a loan purchaser or underwriter).

### DESCRIPTION OF THE FIGURES

FIG. 1 is a block diagram depicting a system for facilitating the aggregation of financial data, in accordance with an embodiment of the present invention.

FIG. 2 is a flowchart illustrating one method of aggregating financial data for loan processing or other purposes, in accordance with an embodiment of the invention.

### DETAILED DESCRIPTION

The following description is presented to enable any person skilled in the art to make and use the invention, and is provided in the context of particular applications of the invention and their requirements. Various modifications to the disclosed embodiments will be readily apparent to those skilled in the art and the general principles defined herein may be applied to other embodiments and applications without departing from the scope of the present invention. Thus, the present invention is not intended to be limited to the embodiments shown, but is to be accorded the widest scope consistent with the principles and features disclosed herein.

In one embodiment of the invention, a system and methods are provided for aggregating a user's financial data from any number of sources, and making the data available to a loan processor, a financial institution or other person or organization. Specific embodiments of the invention are described herein as they may be implemented to facilitate the aggregation and submission of a loan application, but may be readily modified for other types of data and transactions.

The aggregator operates a website or other computer system accessible to a user (e.g., a loan applicant) and loan processor. The user connects to the aggregator site, identifies himself by logging in and/or providing identifying information (e.g., name, social security number). Any relevant financial data the aggregator already possesses (e.g., from a previous retrieval, for user accounts/data maintained by the aggregator) may be automatically retrieved by the aggregator, based on the user's identity, without eliciting further information from the user.

The aggregator then elicits from the user information that will allow the aggregator to retrieve data from appropriate institutions. For example, he may identify one or more asset accounts and the institutions that maintain the accounts. He may also identify the organization that processes his paychecks, a location where his electronic tax return is stored, and/or other institutions holding financial data the user wants the aggregator to retrieve.

Using the provided information, the aggregator connects to the various institutions and organizations and retrieves the specified data (e.g., account balances, pay stubs, a W2 statement, a tax return). Thus, in this embodiment the aggregator proactively retrieves the data in real-time, rather than requesting the data and waiting for it to be provided via electronic mail, regular mail, facsimile, etc. In other embodiments, however, some of the data may not be retrieved in real-time; for example, payroll data may be sent from a payroll provider (e.g., via electronic mail) in response to a request, rather than being actively retrieved.

In one embodiment of the invention, the aggregator stores the data needed for the user's transaction, but serves it to a loan processor or other entity that connects to the aggregator to review the user's application. The aggregator may also package some or all of the data for delivery to another party (e.g., a loan purchaser such as Fannie Mae), in any specified format.

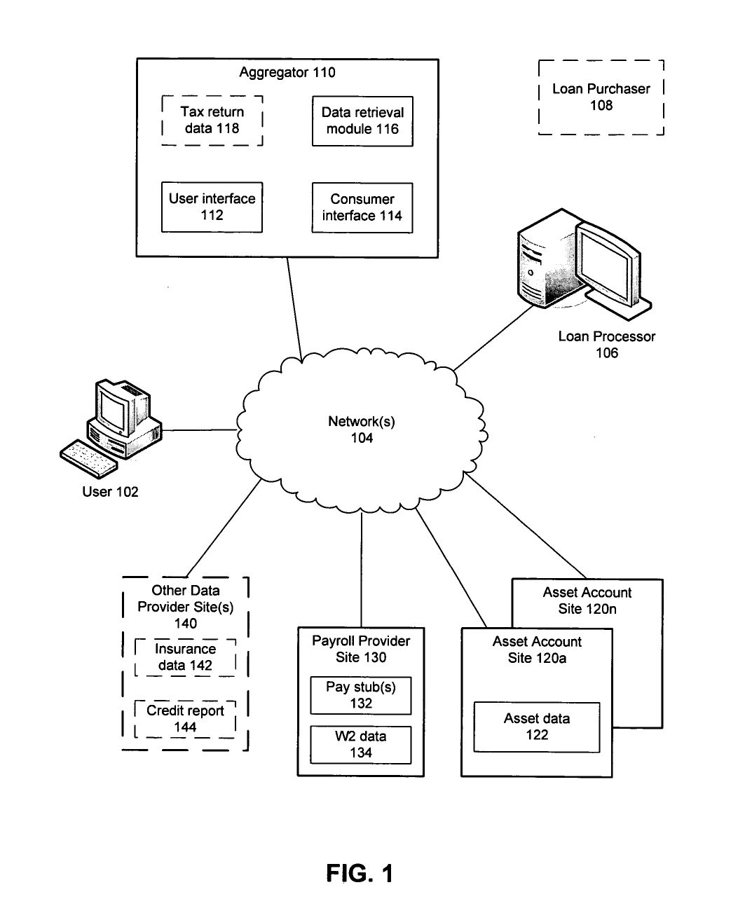

FIG. 1 is a diagram of an environment in which a user's financial data may be aggregated to facilitate loan processing, according to one embodiment of the invention. In this embodiment, a user 102 is applying to loan processor 106 for a loan. The user operates some type of computing device (e.g., a portable computer, a workstation).

The loan processor (e.g., a mortgage company) may request various data from the user to be used to determine whether to grant the loan, including any or all of (but not limited to) the following:

banking statements for savings accounts, checking accounts, money market accounts, certificates of deposit, etc.;

investment statements for brokerage accounts and other investments;

retirement account statements (e.g., 401k, Keogh, IRA);

other asset account statements;

tax returns (e.g., federal, state, local);

W2 statements;

pay stubs;

escrow account information (for a current or past mortgage);

proof of insurance (e.g., property insurance);

credit card statements; and

other credit account statements (e.g., automobile loan, school loan).

Aggregator 110 is configured to assist user 102 and/or loan processor 106 in gathering the desired data, which may reside at or within various electronic sites (e.g., websites) or repositories. It can be seen that the data required by loan processor 106 is unlikely to be all maintained at one location or institution, particularly not in electronic form.

For example, asset account sites 120a-120n may maintain asset data 122 for accounts maintained by corresponding organizations and institutions. The asset data may include balances, account activity, the name(s) or other identifying information (e.g., social security numbers) of people who own the accounts, an address associated with the account, etc.

Payroll provider site 130, operated by a processor of the user's pay, may maintain or store electronic pay stubs 132 (e.g., electronic forms of data reported on pay stubs), W2 data 134 and/or other income or pay-related data. Other sites or repositories 140 may also store financial data of the user that may be requested by loan processor 106, such as insurance data 142 (e.g., property insurance, life insurance), credit report 144 and so on.

The various entities that receive data (e.g., loan processor 106, aggregator 110) or provide data (e.g., user 102, sites 120, 130, 140) in an embodiment of the invention are interconnected via any number and types of communication links (e.g., wired, wireless, dedicated, shared), collectively referred to here as network(s) 104. Networks 104 may therefore include a publicly available network such as the Internet, a private network or intranet, direct connections and/or other links, and so on.

Loan processor 106 may process a loan application from user 102 with an eye toward selling the loan to a loan purchaser 108, which may be coupled to any other parties represented in FIG. 1, through networks 140 and/or other connections.

Aggregator 110, loan processor 106 and sites 120, 130, 140 comprise any number of general- and/or special-purpose computing devices (e.g., file servers, database servers, workstations). In particular, the aggregator may include a web server for interfacing with user 102 and other entities (e.g., loan processor 106), a data server or database management system (DBMS) for storing data, and any number of application programs, utilities and software tools for communicating with other entities and aggregating the user's financial data.

Thus, in the embodiment of FIG. 1, aggregator 110 includes user interface 112 for communicating with user 102 and eliciting information such as login information (e.g., user ID, password) for validating the user's identity within the aggregator, login information for accessing the user's data at site 120, 130 or 140, account numbers, social security number, etc. User interface 112 may be accessed with a browser or other software executing on the user's computing device and may be implemented by a web server.

Aggregator 110 also includes consumer interface 114 for interfacing with loan processor 106 and/or other entities or consumers of a user's financial data. The consumer interface may also be browser-based, and is designed to provide the user's financial data for review or manipulation as part of a loan processing effort.

The aggregator also includes one or more data retrieval modules 116, which are configured to access the user's financial data on sites 120, 130, 140 and/or elsewhere.

In one embodiment of the invention, aggregator 110 comprises or is part of a system for facilitating assembly of a tax return (e.g., federal, state, local) for the user, and may therefore already store tax return data 118. Alternatively, the user's tax return data may be stored electronically on the user's computing device or a site associated with a tax preparer.

In one specific implementation of this embodiment, aggregator 110 is, or is affiliated with, Intuit Inc. In this implementation the user operates one or more finance or tax software products offered by the aggregator (e.g., Quicken®, QuickBooks®, TurboTax®), and may therefore have already entrusted the aggregator to store some of the information that would otherwise be elicited from the user or at least have it in an electronic form accessible to the aggregator.

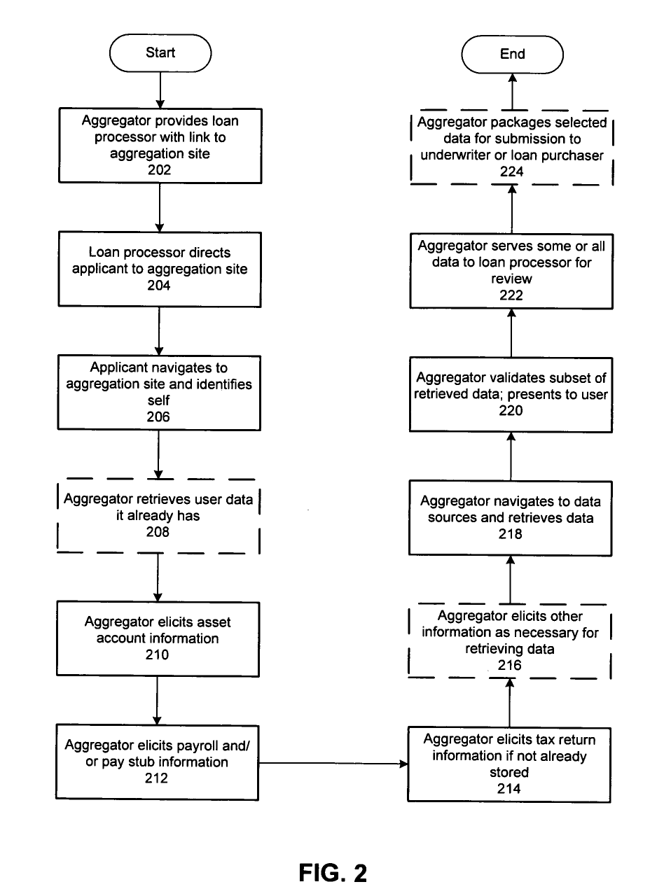

FIG. 2 is a flowchart demonstrating a method of aggregating a user's financial data for submission to a loan processor or other entity, according to one embodiment of the invention.

In operation 202, an aggregator provides the loan processor with a link to an aggregation site (e.g., a website). The aggregation site is configured to elicit information from a user applying for a loan, and to retrieve some or all of the information to access data requested by the loan processor. In this embodiment of the invention, the aggregator is an entity capable of directly accessing users' asset, credit, investment, payroll, tax and/or other data (e.g., insurance) from institutions or organizations that maintain the data.

In operation 204, the loan processor supplies the link to the user. This may be done online (e.g., as part of an online application process sponsored by the loan processor) or through offline media (e.g., telephone, print or television advertisement).

In operation 206, the user navigates to the aggregation site and logs in if he already has an account with the aggregator. Otherwise, he may create or register an account or simply provide information identifying himself (e.g., name, address, social security number, driver's license number). The user interface (e.g., web page) presented to the user may be branded to match the loan processor and/or aggregator.

In optional operation 208, the aggregator retrieves any relevant data the aggregator may already have regarding the user if the user logs in or otherwise authenticates himself. As described above, the user may already use a product or service of the aggregator to assemble a tax return or maintain financial data. In this case, if the tax return data, financial data or other data are stored at an aggregator site (or other site known to and accessible by the aggregator), the aggregator will not need to prompt the user to help retrieve the data.

In operation 210, the aggregator elicits asset information for accessing one or more asset accounts of the user that it does not already have access to. For example, for each account the user wants to disclose to the loan processor, the aggregator may elicit the identity (e.g., name, URL or Uniform Resource Locator) of the institution holding the account, the account name or number, and the user's login information (e.g., a user ID and password). The user may also give the aggregator this information for an account he does not want to disclose to the loan processor (e.g., so that he can access the account through the aggregator).

In operation 212, the aggregator elicits information that will be used to retrieve payroll data (e.g., a pay stub) and/or W2 data. For example, the user may be asked for his payroll provider or, if the payroll provider is not known (and is not his employer) he may be asked for his employer and the aggregator may determine who the payroll provider is. The user may also be asked for his social security number, an employee number or other information.

In operation 214, the aggregator elicits information for retrieving the user's tax return(s) if not already known. For example, the user may be asked for the identity of his online tax preparer, and login information for accessing his return(s). In one implementation of the illustrated embodiment of the invention, the user is provided a link or tool for uploading a tax return from his computing device (and/or for uploading any of the other financial data mentioned herein).

In optional operation 216, the aggregator also elicits information for use in retrieving other data, such as a credit card account statement, a loan statement, proof of insurance, a credit report, etc.

In operation 218, the aggregator connects to the various institutions identified by the user and retrieves the relevant data using the information provided by the user. Thus, the aggregator may log into one or more institutions as the user (i.e., using his user ID and password) and download account balances, statements and other data mentioned above. Multiple retrievals may be performed serially or in parallel.

The aggregator may also retrieve data not specifically requested by the user, such as a credit report from one or all of the credit reporting agencies. The aggregator also uploads data from the user's computing device if necessary.

In operation 220, the aggregator validates or attempts to validate some or all of the retrieved data. For example, the aggregator may compare the user's name, address, social security number or other information with what was retrieved. This may be done to help ensure that only data that actually pertains to the user is reported to the loan processor.

The various data the aggregator was able to assemble are then presented to the user for review. The user can therefore preview the data before actually releasing it to the loan processor. He may decide to have additional data reported (e.g., for another asset or credit account), or may remove some of the data.

The aggregator may store some or all of the retrieved data, and/or the information provided by the user for retrieving the data, permanently or temporarily. In one implementation, data retrieved from institutions external to the aggregator may be stored at least until the loan processor has granted or denied the requested loan.

In operation 222, the aggregator serves some or all of the data to the loan processor. Illustratively, the loan processor navigates to the aggregation site and accesses the user's data through an interface (e.g., a web page) that is customized to the loan processor or that is standard for any number of consumers of aggregated data.

In one implementation of this embodiment of the invention, the loan processor may be able to initiate a request for additional data through the aggregation site. For example, if the user's income or assets are insufficient for approval of the loan, the loan processor may indicate this and the aggregator (or loan processor) can then contact the user. The user may then navigate back to the aggregation site and provide information allowing the aggregator to retrieve additional data (e.g., regarding another asset account).

In optional operation 224, the aggregator packages some or all of the user's data (e.g., data selected by the loan processor) for submission to a loan purchaser or underwriter (e.g., Fannie Mae). The data are packaged into a format specified by the recipient.

Other methods of aggregating a user's financial data for submission to third party may be derived from the method described above, without exceeding the scope of the invention. In general, such methods may involve retrieving: user asset data (e.g., account statements for banking, investment, retirement and/or other accounts) from one or more electronic asset account sites (e.g., websites); user payroll data (e.g., a W2 statement, pay stubs) from an electronic payroll provider site; tax return data (e.g., from the user, from the data aggregator); insurance data (e.g., verification of insurance, proof of payment of an insurance premium) from an electronic insurance provider site; credit data (e.g., statements from credit providers) from an electronic credit provider site; a credit report from an electronic credit reporting site; etc.

The program environment in which a present embodiment of the invention is executed illustratively incorporates a general-purpose computer or a special purpose device such as a hand-held computer. Details of such devices (e.g., processor, memory, data storage, display) may be omitted for the sake of clarity.

It should also be understood that the techniques of the present invention may be implemented using a variety of technologies. For example, the methods described herein may be implemented in software executing on a computer system, or implemented in hardware utilizing either a combination of microprocessors or other specially designed application specific integrated circuits, programmable logic devices, or various combinations thereof. In particular, the methods described herein may be implemented by a series of computer-executable instructions residing on a suitable computer-readable medium. Suitable computer-readable media may include volatile (e.g., RAM) and/or non-volatile (e.g., ROM, disk) memory, carrier waves and transmission media (e.g., copper wire, coaxial cable, fiber optic media). Exemplary carrier waves may take the form of electrical, electromagnetic or optical signals conveying digital data streams along a local network, a publicly accessible network such as the Internet or some other communication link.

The foregoing embodiments of the invention have been presented for purposes of illustration and description only. They are not intended to be exhaustive or to limit the invention to the forms disclosed. Accordingly, the scope of the invention is defined by the appended claims, not the preceding disclosure.

What is claimed is:

1. An automated method of aggregating a user's financial data for submission to a third party, the method comprising:
receiving a connection at an electronic data aggregator site from the user;
receiving from the user information identifying electronic storage locations of financial data to be submitted to the third party;
retrieving asset data of the user from one or more electronic asset account sites;
retrieving payroll data of the user from an electronic payroll provider site;
retrieving electronic tax return data of the user; and
presenting the retrieved data to the third party.

2. The method of claim 1, further comprising:
retrieving insurance data of the user from an electronic insurance organization site.

3. The method of claim 1, further comprising:
retrieving credit data of the user from an electronic credit provider site.

4. The method of claim 1, further comprising:
retrieving a credit report regarding the user from an electronic credit report site.

5. The method of claim 1, further comprising:
validating a subset of the retrieved data to ensure the validated data corresponds to the user.

6. The method of claim 1, further comprising:
retrieving from the data aggregator site financial data of the user to be submitted to the third party.

7. The method of claim 6, wherein the financial data retrieved from the data aggregator site was generated by a financial software program provided by the data aggregator and operated by the user.

8. The method of claim 1, further comprising after said retrieving operations:
presenting the asset data, payroll data and tax return data to the user; and
submitting data selected by the user, from the presented data, to the third party.

9. The method of claim 8, wherein said submitting comprises:
receiving a connection at the electronic data aggregator site from the third party; and
serving the selected data to the third party.

10. The method of claim 1, wherein the asset data and payroll data are retrieved from different websites maintained by different organizations.

11. The method of claim 1, wherein said retrieving asset data comprises:
establishing an electronic connection to an electronic asset account site;
identifying the user and an account of the user to the electronic asset account site; and
receiving the asset data.

12. The method of claim 1, wherein said retrieving payroll data comprises:
establishing an electronic connection to the electronic payroll provider site;
identifying the user to the electronic payroll provider site; and
receiving the payroll data.

13. The method of claim 1, wherein the tax return data is retrieved from a computing device operated by the user.

14. The method of claim 1, wherein the tax return data is retrieved from the electronic data aggregator site.

15. The method of claim 1, further comprising, prior to said retrieving operations:
providing the third party a link to the electronic data aggregator site, for use by the third party in directing the user to the electronic data aggregator site.

16. The method of claim 1, further comprising:
facilitating the third party's selection of financial data of the user for submission to a loan purchaser; and
assembling the selected financial data for submission to the loan purchaser in a format specified by the loan purchaser.

17. A computer readable medium storing instructions that, when executed by a computer, cause the computer to perform a method of aggregating a user's financial data for submission to a third party, the method comprising:
receiving a connection at an electronic data aggregator site from the user;
receiving from the user information identifying electronic storage locations of financial data to be submitted to the third party;
retrieving asset data of the user from one or more electronic asset account sites;
retrieving payroll data of the user from an electronic payroll provider site;
retrieving electronic tax return data of the user; and
presenting the retrieved data to the third party.

18. An electronic system for aggregating a user's financial data for submission to a third party, the system comprising:
a user interface configured to elicit from the user information enabling the system to retrieve a first subset of the financial data from external electronic sites other than the third party;
a consumer interface configured to serve the financial data to the third party;
one or more data retrieval modules configured to retrieve the first subset of the financial data from the electronic sites; and
connections to communication links to:
a computing device operated by the user;
the third party; and
the external electronic sites.

19. The electronic system of claim 18, further comprising:
another data retrieval module configured to retrieve tax return data of the user from a computing device operated by the user.

20. The electronic system of claim 18, further comprising:
a second subset of the financial data including tax return data of the user, wherein the tax return data was generated by a financial software program produced by an organization operating the electronic system.

21. The electronic system of claim 18, wherein the first subset of financial data comprises:
asset data maintained at one or more electronic asset account sites; and
payroll data maintained at an electronic payroll provider site.

22. The electronic system of claim 21, wherein the first subset of financial data further comprises one or more of the group of:
credit data maintained at one or more electronic credit account sites;
insurance data maintained at an electronic insurance provider site; and
a credit report maintained at an electronic credit report site.

23. A method of receiving aggregated financial data of a user via a data aggregator, the method comprising:
receiving from the data aggregator a link to an electronic data aggregation site operated by the data aggregator;
providing the link to the user;
connecting to the data aggregation site after the data aggregator aggregates the financial data of the user from multiple electronic locations; and
receiving the aggregated financial data.

24. The method of claim 23, further comprising:
assembling the aggregated financial data for submission to a loan purchaser in a format specified by the loan purchaser.

25. The method of claim 23, further comprising:
requesting the data aggregator to assemble the aggregated financial data for submission to a loan purchaser in a format specified by the loan purchaser.

26. The method of claim 23, further comprising:
reviewing the aggregated financial data to determine whether to grant a loan to the user.

27. The method of claim 23, further comprising, prior to said receiving the aggregated financial data of the user:
identifying the user to the data aggregator.

28. The method of claim 23, wherein the data aggregator aggregates the financial data of the user by retrieving one or more types of data from the group comprising:
asset data from one or more electronic asset account sites;
payroll data from an electronic payroll provider site;
electronic tax return data;
insurance data from an electronic insurance organization site;
credit data from an electronic credit provider site; and
a credit report from an electronic credit report site.

29. The method of claim 28, wherein the electronic tax return data was generated by a financial software program provided by the data aggregator and operated by the user.

30. The method of claim 23, wherein a subset of the aggregated data is validated to ensure the validated data corresponds to the user.
